(19) United States
(12) Patent Application Publication
(10) Pub. No.: US 2009/0131574 A1
(43) Pub. Date: May 21, 2009

(54) COATED ALUMINUM HYDROXIDE PARTICLES PRODUCED BY MILL-DRYING

(75) Inventors: Rene Gabriel Erich Herbiet, Eupen (BE); Winfried Toedt, Steffeln-Auel (DE); Wolfgang Hardtke, Niederkassel (DE); Hermann Rautz, Graz (AT); Christian Alfred Kienesberger, Kapfenberg (AT); Mario Neuenhaus, Elsdorf (DE)

Correspondence Address: ALBEMARLE CORPORATION;PATENT DEPARTMENT, 451 FLORIDA STREET, BATON ROUGE, LA, 70801, US

(73) Assignee: Martinswerk GmbH, Bergheim (DE)

(21) Appl. No.: 12/304,629

(22) PCT Filed: Jun. 21, 2007
(86) PCT No.: PCT/IB2007/004059

§ 371 Date: Dec. 12, 2008

Related U.S. Application Data
(60) Provisional application No. 60/815,426, filed on Jun. 21, 2006.
(60) Provisional application No. 60/815,515, filed on Jun. 21, 2006.
(60) Provisional application No. 60/818,632, filed on Jul. 5, 2006.
(60) Provisional application No. 60/818,633, filed on Jul. 5, 2006.
(60) Provisional application No. 60/818,670, filed on Jul. 5, 2006.
(60) Provisional application No. 60/828,877, filed on Oct. 10, 2006.
(60) Provisional application No. 60/828,901, filed on Oct. 10, 2006.
(60) Provisional application No. 60/828,908, filed on Oct. 10, 2006.
(60) Provisional application No. 60/828,912, filed on Oct. 10, 2006.
(60) Provisional application No. 60/889,316, filed on Feb. 12, 2007.
(60) Provisional application No. 60/889,320, filed on Feb. 12, 2007.
(60) Provisional application No. 60/889,325, filed on Feb. 12, 2007.
(60) Provisional application No. 60/889,327, filed on Feb. 12, 2007.
(60) Provisional application No. 60/889,329, filed on Feb. 12, 2007.
(60) Provisional application No. 60/889,330, filed on Feb. 12, 2007.
(60) Provisional application No. 60/891,745, filed on Feb. 27, 2007.
(60) Provisional application No. 60/891,746, filed on Feb. 27, 2007.
(60) Provisional application No. 60/891,747, filed on Feb. 27, 2007.
(60) Provisional application No. 60/891,748, filed on Feb. 27, 2007.
(60) Provisional application No. 60/916,477, filed on May 7, 2007.

(51) Int. Cl. C08K 3/22; B05D 7/14; B32B 15/02

(52) U.S. Cl. 524/437; 427/216; 428/407

(57) ABSTRACT

Silane and/or organic titanate and/or organic zirconate coated, mill-dried ATH particles, methods of making them, their use in flame retarded polymer formulations, and molded or extruded articles made from the flame retarded polymer formulations.

### FIELD OF THE INVENTION

The present invention relates to novel, coated aluminum hydroxide flame retardants, methods of making them, and their use.

### BACKGROUND OF THE INVENTION

Aluminum hydroxide has a variety of alternative names such as aluminum hydrate, aluminum trihydrate, aluminum trihydroxide, etc., but it is commonly referred to as ATH. Particulate aluminum hydroxide, hereinafter ATH, finds many uses as a filler in many materials such as, for example, papers, resins, rubber, plastics etc. One of the most prevalent uses of ATH is as a flame retardant in synthetic resins such as plastics and wire and cable.

The industrial applicability of aluminum hydroxide has been known for some time. In the flame retardant area, aluminum hydroxide is used in synthetic resins such as plastics and in wire and cable applications to impart flame retardant properties.

In an effort to provide better compatibility with resins, ATH particles have been coated with a variety of surface active materials including silanes, fatty acids, etc. Typically, the surface active-treatment is deposited onto ATH particles nonuniformly, which leads to the coupling agent or surface active coating working as a binder to strongly coagulate the ATH particles to each other. This coagulation deteriorates the dispersibility of the ATH particles in the resin, an unwanted property. However, when uniform surface-active-treatment can be obtained, the coupling agent or surface-active coating does not work as a binder, and good dispersibility in the selected resin can be maintained. Thus, as the demand for coated ATH particles increases, the demand for processes that can produce uniformly coated ATH particles also increases.

### SUMMARY OF THE INVENTION

In one embodiment, the present invention relates to ATH particles comprising a surface coating agent selected from at least one of i) silanes; ii) organic titanates; and iii) organic zirconates. The ATH particles are produced by mill drying a slurry comprising from about 1 to about 85 wt. % ATH particles, based on the slurry, in the presence of a surface coating agent.

In another embodiment, the present invention relates to a process for producing coated, mill-dried ATH particles comprising mill drying a slurry comprising in the range of from about 1 to about 85 wt. % ATH particles, based on the slurry, in the presence of a surface coating agent, thereby producing coated, mill-dried ATH particles. The surface coating agent can be suitably selected from at least one of i) silanes; ii) organic titanates; and iii) organic zirconates.

In another embodiment, the present invention relates to a process for producing coated, mill-dried ATH particles comprising:
a) combining a slurry comprising in the range of from about 1 to about 85 wt. % ATH particles, based on the slurry, with a surface coating agent selected from at least one of i) silanes; ii) organic titanates; and iii) organic zirconates, thus producing a mixture comprising the slurry and surface coating agent;
b) allowing the slurry and the surface coating agent in the mixture to react for a period of time in the range of from about 1 second to about 30 minutes; and
c) mill drying said mixture thus producing coated, mill-dried ATH particles.

In preferred embodiments, the slurry is heated to a temperature in the range of from about 20 to about 95° C., preferably in the range of from about 80 to about 95° C. before it is combined with the at least one surface coating agent.

In another embodiment, if the surface coating agent is a silane, the present invention relates to a process for producing coated ATH particles comprising
a) mixing at least one, preferably only one, silane with water, preferably deionized water, to form a silane-solution comprising in the range of from about 1 wt % to about 99 wt %, preferably in the range of from about 5 wt % to about 90 wt %, more preferably in the range of from about 20 wt % to about 80 wt %, most %, more preferably in the range of from about 40 wt % to 60 wt %, all based on the total weight of the silane-solution;
b) heating a slurry comprising in the range of from about 1 to about 85 wt. % ATH particles, based on the total weight of the slurry to a temperature in the range of from about 20 to about 95° C., preferably in the range of from about 80 to about 95° C. thus forming a heated slurry;
c) combining said heated slurry with said silane-solution thus forming a silane/ATH containing slurry;
d) maintaining, under mechanical agitation, said silane/ATH containing slurry at a temperature in the range of from about 20 to about 95° C., preferably in the range of from about 80 to about 95° C., for a period of time in the range of from about 1 second to about 30 minutes, preferably in the range of from about 1 second to about 20 minutes, more preferably in the range of from about 1 minute to about 15 minutes, most preferably in the range of from about 5 minutes to about 10 minutes thus forming a mixture; and,
e) mill drying said mixture thus producing coated, mill-dried ATH particles.

In some embodiments, if needed to allow the silane to undergo hydrolysis, at least one, in some embodiments only one, mineral and/or organic, preferably at least one, in some embodiments only one, organic acid, is mixed with the silane along with the water in a). Any organic acid commonly used for hydrolysis of silanes can be used, and it is preferred that formic acid and/or acetic acid be used. In this embodiment less than 10 wt %, preferably less than 1 wt %, more preferably less than 0.1 wt %, based on the weight of the silane, of a mineral or organic acid is added in a). In particularly preferred embodiments, in the range of from about 0.05 wt % to about 10 wt. %, preferably in the range of from about 0.05 wt. % to about 1 wt. %, more preferably in the range of from about 0.05 wt. % to about 0.1 wt. %, all based on the weight of the silane, of a mineral or organic acid is added in a). After the addition of the water and organic acid, the silane solution is continuously stirred for in the range of from about 2 to about 240 minutes, preferably in the range of from about 10 to about 120 minutes, more preferably in the range of from about 30 to about 60 minutes. This silane solution can then be combined with the slurry in c).

### DETAILED DESCRIPTION OF THE INVENTION

ATH as used herein is meant to refer to aluminum hydroxide and the various names commonly used in the art to refer to this mineral flame retardant such as aluminum hydrate, aluminum trihydrate, aluminum trihydroxide, etc.

The present invention involves producing coated, mill-dried ATH particles. These coated, mill-dried ATH particles can be suitably produced by mill drying a slurry containing ATH particles in the presence of a surface coating agent.

### Slurry

The slurry used in the practice of the present invention typically contains in the range of from about 1 to about 85 wt. % ATH particles, based on the total weight of the slurry. In preferred embodiments, the slurry contains in the range of from about 25 to about 70 wt. % ATH particles, more preferably in the range of from about 55 to about 65 wt. % ATH particles, both on the same basis. In other preferred embodiments, the slurry contains in the range of from about 40 to about 60 wt. % ATH particles, more preferably in the range of from about 45 to about 55 wt. % ATH particles, both on the same basis. In still other preferred embodiments, the slurry contains in the range of from about 25 to about 50 wt. % ATH particles, more preferably in the range of from about 30 to about 45 wt. % ATH particles, both on the same basis.

The slurry used in the practice of the present invention can be obtained from any process used to produce ATH particles. Preferably the slurry is obtained from a process that involves producing ATH particles through precipitation and filtration. In an exemplary embodiment, the slurry is obtained from a process that comprises dissolving crude aluminum hydroxide in caustic soda to form a sodium aluminate liquor, which is cooled and filtered thus forming a sodium aluminate liquor useful in this exemplary embodiment. The sodium aluminate liquor thus produced typically has a molar ratio of Na₂O to Al₂O₃ in the range of from about 1.4:1 to about 1.55:1. In order to precipitate ATH particles from the sodium aluminate liquor, ATH seed particles are added to the sodium aluminate liquor in an amount in the range of from about 1 g of ATH seed particles per liter of sodium aluminate liquor to about 3 g of ATH seed particles per liter of sodium aluminate liquor thus forming a process mixture. The ATH seed particles are added to the sodium aluminate liquor when the sodium aluminate liquor is at a liquor temperature of from about 45 to about 80° C. After the addition of the ATH seed particles, the process mixture is stirred for about 100 h or alternatively until the molar ratio of Na₂O to Al₂O₃ is in the range of from about 2.2:1 to about 3.5:1, thus forming an ATH suspension. The obtained ATH suspension typically comprises from about 80 to about 160 g/l ATH, based on the suspension. However, the ATH concentration can be varied to fall within the ranges described above. The obtained ATH suspension is then filtered and washed to remove impurities therefrom, thus forming a filter cake. The filter cake can be washed one, or in some embodiments more than one, times with water, preferably de-salted water. The filter cake can be re-slurried with water to form a slurry, or in another preferred embodiment, at least one, preferably only one, dispersing agent is added to the filter cake to form a slurry having an ATH concentration in the above-described ranges. It should be noted that it is also within the scope of the present invention to re-slurry the filter cake with a combination of water and a dispersing agent. Non-limiting examples of dispersing agents suitable for use herein include polyacrylates, organic acids, naphtalensulfonate/formaldehyde condensate, fatty-alcohol-polyglycol-ether, polypropylene-ethylenoxid, polyglycol-ester, polyamine-ethylenoxid, phosphate, polyvinylalcohole. If the slurry comprises a dispersing agent, the slurry may contain up to about 85 wt. % ATH, based on the total weight of the slurry, because of the effects of the dispersing agent. In this embodiment, the remainder of the slurry (i.e. not including the ATH particles and the dispersing agent(s)) is typically water, although some reagents, contaminants, etc. may be present from precipitation.

In some embodiments, the ATH particles in the slurry are generally characterized as having a BET in the range of from about 1.0 to about 30 m²/g. In preferred embodiments, the ATH particles in the slurry have a BET in the range of from about 1.0 to about 4.0 m²/g, preferably in the range of from about 1.5 to about 2.5 m²/g. The ATH particles in the slurry can be further characterized as having a d₅₀ in the range of from about 1.8 to about 3.5 μm. In preferred embodiments, the ATH particles in the slurry have a d₅₀ in the range of from about 1.8 to about 2.5 μm.

In other embodiments, the ATH particles in the slurry are characterized as having a BET in the range of from about 4.0 to about 8.0 m²/g. In preferred embodiments, the ATH particles in the slurry have a BET in the range of from about 5 to about 7 m²/g.

The ATH particles in the slurry can be further characterized as having a d₅₀ in the range of from about 1.5 to about 2.5 μm. In preferred embodiments, the ATH particles in the slurry have a d₅₀ in the range of from about 1.6 to about 2.0 μm.

In still other embodiments, the ATH particles in the slurry are characterized as having a BET in the range of from about 8.0 to about 14 m²/g. In preferred embodiments, the ATH particles in the slurry have a BET in the range of from about 9 to about 12 m²/g.

The ATH particles in the slurry can be further characterized as having a d₅₀ in the range of from about 0.5 to about 1.6 μm. In preferred embodiments, the ATH particles in the slurry have a d₅₀ in the range of from about 0.8 to about 1.4 μm.

### Surface Coating Agent

The surface coating agent used herein can be selected from at least one of i) silanes; ii) organic titanates; and iii) organic zirconates. In some embodiments, the surface coating agent is selected from silanes, titanates, zirconates, and mixtures thereof. In other embodiments, the surface coating agent is a silane or a titanate or a zirconate.

Silane as used herein is used in its broadest sense and is meant to include alkyl silanes, vinyl silanes, epoxy silanes, and the like. Non-limiting examples of silanes suitable for use herein include those described, for instance, in the technical brochures from DEGUSSA AG under the brand name Dynasylan®, for example, the vinyl silanes VTMO, VTEO, VTMOEO, DS 6498, amino silanes like AMEO, DAMO, alkyl silanes like OCTEO, and the like, and epoxy silanes like GLYMO, etc.

In some embodiments, the alkyl silane is one that has at least one alkyl group with at least 3 carbon atoms. Alkyl group, as used herein and unless otherwise indicated, is meant to refer to linear or branched primary, secondary, or tertiary alkyl groups. Non-limiting examples of suitable alkyl groups include methyl, ethyl, propyl, isopropyl, butyl, isobutyl, hexyl, octyl, isooctyl (6-methylheptyl), 2-ethylhexyl, dodecyl, tetradecyl, hexadecyl, octadecyl, and the like.

In some embodiments, the alkylsilanes used herein are described by the formula R¹Si(OR²)₃, where R¹ is a linear or branched alkyl group having from about 3 to about 30 carbon atoms, and R² is a linear or branched alkyl group having from about 1 to about 6 carbon atoms. More preferably, alkylsilanes suitable for use herein are those wherein R¹ is a linear or branched alkyl group having from about 8 to about 18 carbon atoms, most preferably 12 to 14 carbon atoms, and R² is a linear or branched alkyl group having from about 1 to about 4 carbon atoms.

Organic titanates and organic zirconates suitable for use herein are also known in the art and are readily available commercially. For example, organic titanates and organic zirconates can be readily obtained under the name TYZOR® from Dupont. Preferably, organic titanates used herein are those having the formula R³OTi(OR⁴)₃, wherein R³ is a linear or branched alkyl group having from about 1 to about 14 carbon atoms, and R⁴ is a linear or branched alkyl group having from about 6 to about 12 carbon atoms or an acyl group having from about 8 to about 30 carbon atoms. In some preferred embodiments, the organic titanates used herein are those wherein R³ is isopropyl and R⁴ is isostearoyl, while in other preferred embodiments the organic titante is one wherein R³ and R⁴ are the same and are selected from isooctyl and 2-ethlyhexyl.

Preferably the organic zirconates used herein are those having the formula R⁵OZr(OR⁶)₃, where R⁵ is a linear or branched alkyl group having from about 1 to about 12 carbon atoms, and R⁶ is a linear or branched alkyl group having from about 6 to about 12 carbon atoms or an acyl group having from about 8 to about 30 carbon atoms.

Typically, the amount of surface coating agent introduced into the mill-drying unit is that amount effective at producing mill-dried, coated ATH particles comprising in the range of from about 0.05 to about 5.0 wt. % of the surface coating agent, based on the weight of the uncoated ATH. For example, a 1% coating level as used herein means that 0.1 kg of the surface coating agent, e.g. a silane, is added to a slurry containing 10 kg of ATH, and, thus 10.1 kg of coated ATH is produced. Thus, producing coated, mill-dried ATH from a slurry containing 55 wt % ATH with 1 wt. % of a silane would mean that 0.55 wt. % of the silane is added to the slurry. In other words, we would add 0.55 kg of a silane to 100 kg of a slurry containing 55 kg of uncoated ATH to produce coated, mill-dried ATH particles comprising 1 wt. % of a silane.

Generally, the amount of surface coating agent used herein ranges from about 0.25 to about 3 wt. %, based on the weight of the uncoated ATH in the slurry, preferably in the range of from about 0.5 to about 2.0 wt. %, on the same basis.

### Combining of the Slurry and Surface Coating Agent

In the practice of the present invention, the slurry and the surface coating agent are combined prior to mill drying. In preferred embodiments, the slurry is heated to a temperature in the range of from about 20 to about 95° C., preferably in the range of from about 80 to about 95° C. before it is combined with the at least one surface coating agent. The means by which the slurry and surface coating agent are combined is not critical to the instant invention, and any suitable technique can be used as long as adequate mixing is achieved. Non-limiting examples of suitable techniques for combining the slurry and surface coating agent include the use of a storage vessel, an agitated storage vessel, a simple “t-valve”, any valve suitable for introducing one stream into another stream, the use of a “t-valve” followed by an in-line mixture, or any other mixing apparatus known in the art that will provide a substantially homogenous mixture comprising the slurry and surface coating agent. In preferred embodiments, the slurry and surface coating agent are combined by any technique described above and then conducted through a suitable in-line mixer to ensure further intensive, turbulent mixing of the slurry and the surface coating agent.

After the mixture is formed, while maintaining the temperature of the mixture close to, preferably within the range described above, the temperature of the preheated slurry, the slurry and the surface coating agent in the mixture are allowed to react for a period of time in the range of from about 1 second to about 30 minutes, preferably in the range of from about 1 minute to about 20 minutes, more preferably in the range of from about 1 minute to about 15 minutes, most preferably in the range of from about 5 minute to about 15 minutes, before the mixture is mill-dried. In an exemplary embodiment of the instant invention, the slurry and the surface coating agent in the mixture are allowed to react for a period of time in the range of from about 5 seconds to about 10 minutes.

### Mill Drying

“Mill-drying” and “mill-dried” as used herein, is meant that the ATH particles in the slurry and/or mixture are simultaneously milled and dried in a turbulent hot air-stream in a mill-drying unit in the presence of the surface coating agent. The mill-drying unit comprises a rotor that is firmly mounted on a solid shaft that rotates at a high circumferential speed. The rotational movement in connection with a high air through-put converts the through-flowing hot air into extremely fast air vortices which take up the slurry to be dried, accelerate it, and distribute and dry the slurry to produce coated, mill dried ATH particles. After having been dried completely, the mill-dried, coated ATH particles are transported via the turbulent air out of the mill and separated from the hot air and vapors by using conventional filter systems. In another embodiment of the present invention, after having been dried completely, the mill-dried, coated ATH particles are transported via the turbulent air through an air classifier which is integrated into the mill, and are then transported via the turbulent air out of the mill and separated from the hot air and vapors by using conventional filter systems.

The throughput of the hot air used in the mill-drying unit is typically greater than about 3,000 Bm³/h, preferably greater than about to about 5,000 Bm³/h, more preferably from about 3,000 Bm³/h to about 40,000 Bm³/h, and most preferably from about 5,000 BMm³/h to about 30,000 Bm³/h.

In order to achieve throughputs this high, the rotor of the mill drying unit typically has a circumferential speed of greater than about 40 m/sec, preferably greater than about 60 m/sec, more preferably greater than 70 m/sec, and most preferably in a range of about 70 m/sec to about 140 m/sec. The high rotational speed of the motor and high throughput of hot air results in the hot air stream having a Reynolds number greater than about 3,000.

The temperature of the hot air used in the mill-drying unit is generally greater than about 150° C., preferably greater than about 270° C. In a more preferred embodiment, the temperature of the hot air stream is in the range of from about 150° C. to about 550° C., most preferably in the range of from about 270° C. to about 500° C.

### Coated Mill-Dried ATH Particles

As stated above, the mill drying of the mixture, and/or the slurry in the presence of the surface coating agent, results in coated, mill-dried ATH particles.

Thus, in one embodiment, the present invention relates to coated, mill dried ATH particles, characterized as having a d₅₀ of less than about 15 μm. The coated, mill-dried ATH particles produced by the present invention can also be characterized as having a d₅₀ in the range of from about 0.5 to 2.5 μm. In preferred embodiments, the mill-dried ATH particles produced by the present invention have a d₅₀ in the range of from about 1.5 to about 2.5 μm, more preferably in the range of from about 1.8 to about 2.2 μm. In other preferred embodiments, the mill-dried ATH particles produced by the present invention have a d₅₀ in the range of from about 1.3 to about 2.0 μm, more preferably in the range of from about 1.4 to about 1.8 μm. In still other preferred embodiments, the mill-dried ATH particles produced by the present invention have a d₅₀ in the range of from about 0.5 to about 1.8 μm, more preferably in the range of from about 0.8 to about 1.4 μm.

It should be noted that all particle diameter measurements, i.e. d₅₀, disclosed herein were measured by laser diffraction using a Cilas 1064 L laser spectrometer from Quantachrome. Generally, the procedure used herein to measure the d₅₀, can be practiced by first introducing a suitable water-dispersant solution (preparation see below) into the sample-preparation vessel of the apparatus. The standard measurement called “Particle Expert” is then selected, the measurement model “Range 1” is also selected, and apparatus-internal parameters, which apply to the expected particle size distribution, are then chosen. It should be noted that during the measurements the sample is typically exposed to ultrasound for about 60 seconds during the dispersion and during the measurement. After a background measurement has taken place, from about 75 to about 100 mg of the sample to be analyzed is placed in the sample vessel with the water/dispersant solution and the measurement started. The water/dispersant solution can be prepared by first preparing a concentrate from 500 g Calgon, available from KMF Laborchemie, with 3 liters of CAL Polysalt, available from BASF. This solution is made up to 10 liters with deionized water. 100 ml of this original 10 liters is taken and in turn diluted further to 10 liters with deionized water, and this final solution is used as the water-dispersant solution described above.

The coated, mill-dried ATH particles according to the present invention are also characterized as having in the range of from about 0.05 to about 5.0 wt. %, preferably in the range of from about 0.25 to about 2.0 wt. %, of the surface coating agent, based on the total weight of the uncoated, mill-dried ATH particles.

The coated, mill-dried, ATH particles according to the present invention can also be characterized by the BET specific surface area, as determined by DIN-66132, of the uncoated ATH particles, i.e. the uncoated ATH substrate, is generally in the range of from about 1 to 30 m²/g. In some embodiments, the BET specific surface is in the range of from about 3 to about 6 m²/g, more preferably in the range of from about 3.5 to about 5.5 m²/g. In other embodiments, the BET specific surface is in the range of from about 6 to about 9 m²/g, more preferably in the range of from about 6.5 to about 8.5 m²/g. In still other embodiments, the BET specific surface is in the range of from about 9 to about 15 m²/g, more preferably in the range of from about 10.5 to about 12.5 m²/g.

### Use of the Coated, Mill-Dried ATH Particles

The ATH particles according to the present invention can be used as a flame retardant in a variety of synthetic resins. Thus, in one embodiment, the present invention relates to a flame retarded polymer formulation comprising at least one synthetic resin, in some embodiments only one, and a flame retarding amount of mill-dried, coated ATH particles according to the present invention, and molded and/or extruded articles made from the flame retarded polymer formulation.

By a flame retarding amount of the mill-dried, coated ATH particles, it is generally meant in the range of from about 5 wt % to about 90 wt %, based on the weight of the flame retarded polymer formulation, preferably in the range of from about 20 wt % to about 70 wt %, on the same basis. In a most preferred embodiment, a flame retarding amount is in the range of from about 30 wt % to about 65 wt % of the mill-dried, coated ATH particles, on the same basis. Thus, the flame retarded polymer formulation typically comprises in the range of from about 10 to about 95 wt. % of the at least one synthetic resins, based on the weight of the flame retarded polymer formulation, preferably in the range of from about 30 to about 40 wt. % of the flame retarded polymer formulation, more preferably in the range of from about 35 to about 70 wt. % of the flame retarded polymer formulation, all on the same basis.

Non-limiting examples of thermoplastic resins where the ATH particles find use include polyethylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, vinyl chloride-propylene copolymer, vinyl acetate resin, phenoxy resin, and the like. Further examples of suitable synthetic resins include thermosetting resins such as epoxy resin, phenol resin, melamine resin, unsaturated polyester resin, alkyd resin and urea resin and natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included. Further included are polymeric suspensions (latices).

Preferably, the synthetic resin is a polyethylene-based resins such as high-density polyethylene, low-density polyethylene, linear low-density polyethylene, ultra low-density polyethylene, EVA (ethylene-vinyl acetate resin), EEA (ethylene-ethyl acrylate resin), EMA (ethylene-methyl acrylate copolymer resin), EAA (ethylene-acrylic acid copolymer resin) and ultra high molecular weight polyethylene; and polymers and copolymers of C₂ to C₈ olefins (α-olefin) such as polybutene and poly(4-methylpentene-1), polyvinyl chloride and rubbers. In a more preferred embodiment, the synthetic resin is a polyethylene-based resin.

The flame retarded polymer formulation can also contain other additives commonly used in the art. Non-limiting examples of other additives that are suitable for use in the flame retarded polymer formulations of the present invention include extrusion aids such as polyethylene waxes, Si-based extrusion aids, fatty acids; coupling agents such as amino-, vinyl- or alkyl silanes or maleic acid grafted polymers; barium stearate or calcium sterate; organoperoxides; dyes; pigments; fillers; blowing agents; deodorants; thermal stabilizers; antioxidants; antistatic agents; reinforcing agents; metal scavengers or deactivators; impact modifiers; processing aids; mold release aids, lubricants; anti-blocking agents; other flame retardants; UV stabilizers; plasticizers; flow aids; and the like. If desired, nucleating agents such as calcium silicate or indigo can be included in the flame retarded polymer formulations also. The proportions of the other optional additives are conventional and can be varied to suit the needs of any given situation.

The methods of incorporation and addition of the components of the flame-retarded polymer formulation and the method by which the molding is conducted is not critical to the present invention and can be any known in the art so long as the method selected involves uniform mixing and molding. For example, each of the above components, and optional additives if used, can be mixed using a Buss Ko-kneader, internal mixers, Farrel continuous mixers or twin screw extruders or in some cases also single screw extruders or two roll mills, and then the flame retarded polymer formulation molded in a subsequent processing step. Further, the molded article of the flame-retardant polymer formulation may be used after fabrication for applications such as stretch processing, emboss processing, coating, printing, plating, perforation or cutting. The kneaded mixture can also be inflation-molded, injection-molded, extrusion-molded, blow-molded, press-molded, rotation-molded or calender-molded.

In the case of an extruded article, any extrusion technique known to be effective with the synthetic resin(s) used in the flame retarded polymer formulation can be employed. In one exemplary technique, the synthetic resin, mill-dried, coated ATH particles, and optional components, if chosen, are compounded in a compounding machine to form the flame-retardant resin formulation. The flame-retardant resin formulation is then heated to a molten state in an extruder, and the molten flame-retardant resin formulation is then extruded through a selected die to form an extruded article or to coat for example a metal wire or a glass fiber used for data transmission.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount.

The following examples will illustrate the present invention, but are not meant to be limiting in any manner.

### EXAMPLES

### Example 1

All d₅₀, BET, oil absorption, etc., unless otherwise indicated, were measured according to the techniques described above. “phr” is used herein as an abbreviation for “parts per hundred resin”.

### Example 1

1000 kg of a slurry comprising 510 kg of uncoated ATH was heated to a temperature of 80° C. The ATH in the slurry had a BET specific surface area of 3.6 m²/g and a median particle size of 1.92 μm. A 50 wt. % solution of the vinyl silane Dynasylan® VTMO from Degussa was prepared in de-ionized water. 0.2 wt. %, based on the silane, of a 10% solution of formic acid was added to the water/silane solution under stirring. 1000 kg of the heated slurry, thus containing 510 kg of uncoated ATH was combined with 10.2 kg of the silane/water/formic acid solution under mechanical agitation during 8 minutes. The ATH/water/silane/formic acid solution was fed to a drying mill at a feed rate of 400 l/h. The mill was operated under conditions that included an air flow rate of between 4100-4200 Bm³/h, a temperature of 290-320° C., and a rotor speed of 80 m/s.

Coated, mill-dried aluminum hydroxide particles were collected from the hot air stream via an air filter system.

### Example 2

80 phr (about 295.8 g) of ethylene vinyl acetate (EVA) Escorene™ Ultra UL00328 from ExxonMobil together with 20 phr (about 73.9 g) of Exceed™ ML2518 from ExxonMobil and 0.07 phr (about 0.26 g) of Perkadox BC from Akzo Nobel was mixed during about 20 min on a two roll mill W150M from the Collin company with 170 phr (about 628.5 g) of the inventive aluminum hydroxide grade produced in Example 1 in a usual manner familiar to a person skilled in the art, and 0.4 phr (about 1.5 g) of the antioxidant Ethanox® 310 from Albemarle Corporation. The temperature of the two rolls was set to 170° C. The ready compound was removed from the mill, and after cooling to room temperature, was further reduced in size to obtain granulates suitable for compression molding in a two plate press or for feeding a laboratory extruder to obtain extruded strips for further evaluation. In order to determine the mechanical properties of the flame retardant resin formulation, granules were extruded into 2 mm thick tapes using a Haake Polylab System with a Haake Rheomex extruder. Test bars according to DIN 53504 were punched out of the tape. The results of this experiment are contained in Table 1, below.

### Example 3—COMPARATIVE 1

80 phr (about 295.8 g) of ethylene vinyl acetate (EVA) Escorene™ Ultra UL00328 from ExxonMobil together with 20 phr (about 73.9 g) of Exceed™ ML2518 from ExxonMobil and 0.07 phr (about 0.26 g) of Perkadox BC from Akzo Nobel was mixed during about 20 min on a two roll mill W150M from the Collin company with 170 phr (about 628.5 g) of an uncoated ATH. The uncoated ATH used in this comparative example had the same BET and d₅₀ values as in Example 1 prior to coating, i.e. 3.6 m²/g and 1.92 μm respectively. Mixing on the two roll mill was done in a usual manner familiar to a person skilled in the art, together with 0.4 phr (about 1.5 g) of the antioxidant Ethanox® 310 from Albemarle Corporation. The temperature of the two rolls was set to 170° C. The ready compound was removed from the mill, and after cooling to room temperature, was further reduced in size to obtain granulates suitable for compression molding in a two plate press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder. Test bars according to DIN 53504 were punched out of the tape. The results of this experiment are contained in Table 1, below.

### Example 4—COMPARATIVE 2

80 phr (about 295.8 g) of ethylene vinyl acetate (EVA) Escorene™ Ultra UL00328 from ExxonMobil together with 20 phr (about 73.9 g) of Exceed™ ML2518 from ExxonMobil and 0.07 phr (about 0.26 g) of Perkadox BC from Akzo Nobel was mixed during about 20 min on a two roll mill W150M from the Collin company with 170 phr (about 628.5 g) of a coated ATH. Coating of this non-inventive ATH was performed in a conventional way using the same coating agents and levels as in Example 1, but according to the description in U.S. Pat. No. 5,827,906. The ATH used in this comparative example had the same BET and d₅₀ values as in Example 1 prior to coating, i.e. 3.6 m²/g and 1.92 μm respectively. Mixing on the two-roll mill was done in a usual manner familiar to a person skilled in the art, together with 0.4 phr (about 1.5 g) of the antioxidant Ethanox™ 310 from Albemarle Corporation. The temperature of the two rolls was set to 170° C. The ready compound was removed from the mill, and after cooling to room temperature, was further reduced in size to obtain granulates suitable for compression molding in a two plate press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder. Test bars according to DIN 53504 were punched out of the tape. The results of this experiment are contained in Table 1, below.

TABLE 1

| | Comparative 1 | Comparative 2 | Inventive |
|---|---|---|---|
| | (uncoated) | (conventional coating) | filler |
| Melt Flow Index | 1.2 | 3.2 | 4.1 |
| @ 150° C./21.6 kg | | | |
| (g/10 min) | | | |
| Tensile strength | 9.5 | 10.0 | 11.7 |
| (MPa) | | | |
| Elongation at | 106 | 169 | 200 |
| break (%) | | | |
| LOI (% O₂) | 35.1 | 36 | 36.2 |

As can be seen in Table 1, due to the more uniform coating, the inventive aluminum hydroxide according to the present invention provides for the best theological and mechanical properties.

The Melt Flow Index (MFI) was measured in accordance with DIN-ISO 1133, tensile strength & elongation at break in accordance with DIN 53504 & EN ISO 527, the limiting oxygen index LOI according to ISO 4589-2 on 150×6×3 mm³ samples.

1-47. (canceled)

48. A process for producing coated, mill-dried ATH particles comprising:
a) combining a slurry comprising in the range of from about 1 to about 85 wt. % ATH particles, based on the slurry, with a surface coating agent selected from at least one of i) silanes; ii) organic titanates; and iii) organic zirconates, thus producing a mixture comprising the slurry and surface coating agent;
b) allowing the slurry and the surface coating agent in the mixture to react for a period of time in the range of from about 1 second to about 30 minutes; and
c) mill drying said mixture thus producing coated, mill-dried ATH particles.

49. The process according to claim 48 wherein the slurry is heated to a temperature in the range of from about 20 to about 95° C. or a temperature in the range of from about 80 to about 95° C. before it is combined with the at least one surface coating agent.

50. The process according to claim 48 wherein said mill drying is conducted in a mill-drying unit operated under conditions including a throughput of a hot air stream greater than about 3000 Bm³/h, a rotor circumferential speed of greater than about 40 m/sec, wherein said hot air stream has a temperature of greater than about 150° C. and a Reynolds number greater than about 3000.

51. The process according to claim 48 wherein said slurry is obtained from a process that involves producing ATH particles through precipitation and filtration.

52. The process according to claim 48 wherein said slurry is obtained from a process that comprises:
a) dissolving crude aluminum hydroxide in caustic soda to form a sodium aluminate liquor, which is cooled and filtered thus forming a sodium aluminate liquor having a molar ratio of Na₂O to Al₂O₃ in the range of from about 1.4:1 to about 1.55:1;
b) adding ATH seed particles to the sodium aluminate liquor in an amount in the range of from about 1 g of ATH seed particles per liter of sodium aluminate liquor to about 3 g of ATH seed particles per liter of sodium aluminate liquor thus forming a process mixture, wherein the ATH seed particles are added to the sodium aluminate liquor when the sodium aluminate liquor is at a liquor temperature of from about 45 to about 80° C.;
c) stirring said sodium aluminate, which contains said seed particles for about 100 h or alternatively until the molar ratio of Na₂O to Al₂O₃ is in the range of from about 2.2:1 to about 3.5:1, thus forming an ATH suspension, which comprises from about 80 to about 160 g/l ATH, based on the suspension;
d) washing and filtering said ATH suspension thus forming a filter cake; and
e) optionally washing said filter cake one or more times with water.
f) reslurrying said filter cake thus forming a slurry.

53. The process according to claim 52 wherein said slurry is obtained by re-slurrying said filter cake with i) water; ii) a dispersing agent; or iii) combinations of i) and ii).

54. The process according to claim 52 wherein the uncoated ATH particles in said slurry have a BET in the range of from about 1.0 to about 30 m²/g and a d₅₀ in the range of from about 0.8 to about 3.5 μm, and/or said coated, mill-dried ATH particles comprise in the range of from about 0.05 to about 5.0 wt. % of the surface coating agent, based on the weight of the uncoated ATH.

55. The process according to claim 48 wherein said surface coating agent is a silane.

56. The process according to claim 55 wherein said process further comprises:
a) mixing at least one, preferably only one silane with water, to form a silane-solution comprising in the range of from about 1 wt % to about 99 wt %, based on the total weight of the silane-solution, of the at least one silane;
b) heating the slurry comprising in the range of from about 1 to about 85 wt. % ATH particles, based on the total weight of the slurry to a temperature in the range of from about 20 to about 95° C., thus forming a heated slurry;
c) combining said heated slurry with said silane-solution thus forming a silane/ATH containing slurry;
d) maintaining, under mechanical agitation, said silane/ATH containing slurry at a temperature in the range of from about 20 to about 95° C., for a period of time in the range of from about 1 second to about 30 minutes, and,
e) mill drying said silane/ATH containing slurry from d) thus producing coated, mill-dried ATH particles.

57. The process according to claim 56 wherein at least one mineral and/or organic acid is mixed with the silane and water in a).

58. The process according to claim 57 wherein:
a) said at least one mineral and/or organic acid is selected from formic acid and/or acetic acid; or,
b) less than 10 wt %, based on the weight of the silane, of the at least one mineral and/or organic acid is added in a); or,
c) after the addition of the water and the at least one mineral and/or organic acid, the solution is continuously stirred for in the range of from about 2 to about 240 minutes; or,
d) any combination of a), b), and c).

59. A flame retarded polymer formulation comprising:
a) in the range of from about 10 to about 95 wt. %, based on the weight of the flame retarded polymer formulation, of at least one synthetic resin;
b) in the range of from about 5 to about 90 wt. % of coated, mill-dried ATH particles; and,
c) optionally, one or more of: i) extrusion aids such as polyethylene waxes, Si-based extrusion aids; ii) fatty acids; iii) coupling agents such as amino-, vinyl- or alkyl silanes or maleic acid grafted polymers; iv) barium stearate or calcium sterate; v) organoperoxides; vi) dyes; vii) pigments; viii) fillers; ix) blowing agents; x) deodorants; xi) thermal stabilizers; xii) antioxidants; antistatic agents; xiii) reinforcing agents; xiv) metal scavengers or deactivators; xv) impact modifiers; xvi) processing aids; xvii) mold release aids, xviii) lubricants; xix) anti-blocking agents; xx) other flame retardants; xxi) UV stabilizers; xxii) plasticizers; xxiii) flow aids; xxiv) nucleating agents such as calcium silicate or indigo; xxv) and the like.
wherein said coated, mill-dried ATH particles are produced by mill drying in a mill-drying unit a slurry comprising from about 1 to about 85 wt. % ATH particles, based on
the slurry, in the presence of a surface coating agent selected from at least one of i) silanes; ii) organic titanates; and iii) organic zirconates.

60. The flame retarded polymer formulation according to claim 59 wherein said flame retarded polymer formulation comprising in the range of from about 30 wt % to about 65 wt % of the coated, mill-dried ATH particles and in the range of from about 35 to about 70 wt. % of the at least one synthetic resin.

61. A molded or extruded article made from the flame retarded polymer formulation according to claim 59.

62. The coated mill dried ATH particles according to claim 48.
